(19) United States
(12) Patent Application Publication
(10) Pub. No.: US 2005/0137923 A1
(43) Pub. Date: Jun. 23, 2005

(54) Using operational information in strategic decision making

(76) Inventor: Bernd Mosbrucker, Ilsfeld-Schozach (DE)

Correspondence Address: FISH & RICHARDSON, P.C., PO BOX 1022, MINNEAPOLIS, MN, 55440-1022, US

(21) Appl. No.: 10/744,951

(22) Filed: Dec. 22, 2003

(51) Int. Cl. G06F 17/60

(52) U.S. Cl. 705/8

(57) ABSTRACT

A business process, such as a transportation process for selecting transportation agents to transport goods, is monitored during an operational stage so that notifications are given that the business process may need to be revised. The business process is executed during the operational stage and has been formulated during a planning stage based on at least one selected parameter that is projected to occur in the operational stage. During the operational stage, the at least one selected parameter is monitored to determine if the projection for the at least one selected parameter is accurate. If the projection for the at least one selected parameter is determined to be inaccurate, the business process, during the operational stage, is revised based on information that is collected during the monitoring of the at least one selected parameter.

### BACKGROUND

This invention relates to the evaluation of information related to business processes. A company typically has to make strategic decisions in the various business areas in which the company operates in order to remain competitive and profitable. In addition, most companies must also monitor ongoing processes and operational data for the purpose of evaluating or revising previously made strategic decisions. Typically, these monitoring and evaluation activities occur as single, or periodic, events when the companies are about to define new strategies for upcoming time periods, in many cases as rarely as every couple of years. Sometimes, the infrequent monitoring of activities can result in a problem going undetected for a significant period of time before corrective measures are taken.

One example of the general problem discussed above comes from logistics processes associated with the transportation of goods, from procurement of the goods to their actual shipment. Transportation processes typically start during a planning stage with an analysis of historical data relating to prior shipments. Based on the historical data, a shipment forecast is made for an upcoming time period. The forecast may include, for example, quantities of goods to be shipped and characteristics for the shipments. By way of example, the characteristics may include such characteristics as origination and destination locations for the shipments, distances to be shipped, and other characteristics about the shipment. The historical and forecast data are then used to define standard shipment “packages” in which actual shipments will later be made during an operational stage. A package, for example, may be something such as 100 crates of apples from location A to location B. During the operational stage, packages, or sub-packages, are “nominated,” or that is, assigned, to different contracted transportation agents, for example, carriers and freight forwarders.

In addition to the planning stage tasks of forecasting and formulating the standard shipping packages, the planning stage may also include the task of forming a contract with each of the transportation agents that will be used to transport shipments. These contracts define a freight tariff that the transportation agent will charge for a shipment of each of the defined shipment packages that the transportation agent may be nominated to ship. In other words, only carriers whose contracts cover certain defined packages are authorized to ship those packages. As such, the contracts create capacity limitations; for example, if only transportation agents A and B are contracted to ship a particular defined shipping package, then the shipping capacity to ship that package is limited to the capacity limitations of those two contracted transportation agents. The contracts are typically based on decision drivers (such as prices and capacity commitments), time frames, service levels (such as lead-time, shipment and processing time), and internal Key Performance Indicators (KPIs) such as damage rates, or personal preferences.

When an actual shipment is to be assigned to a carrier, logistical key figures (such as shipment time) are the primary factors considered, but freight costs are also calculated in order to evaluate which service provider offers the lowest price for a shipment. Based on operational decision drivers, such as freight costs, actual availability of trucks (i.e., the difference between truck allocations per month and daily availability of trucks) or trailers that are already available on the plant, and the strategic goals, a decision is made and the shipment is then assigned to a company that can meet the shipper's criteria. After the shipment is executed, the executed shipment serves as historical data when the next period's budgeting and contracting triggers the complete process again. In this shipment life cycle process, a problem with a shipment or a carrier can thus remain unnoticed until the next period's budgeting and contracting starts.

In most cases, the transportation planning functions and operational functions are performed by different departments within a company. For example, the planning functions may be performed by a central procurement and contracting department, and the operational functions may be performed by distributed shipping departments. The trend is toward more centralization of the procurement and contracting functions. This trend makes the collection of feedback from operations more difficult.

In addition, the time period before a contract can be renegotiated is often substantial. For example, contracts in the ocean freight area are typically negotiated on an annual or bi-annual basis. The contracts normally represent a total number of shipments or containers, or a certain amount of weight related to the time period for the contract's validity. When total quantities are assigned to a time period, a common assumption is that the shipments will be evenly distributed during the time period. However, deviations linked to seasonal changes or market impacts can lead to both overcapacities and under capacities at certain times. If the contract period is shortened in order to reduce the problems, the shipper runs a risk of getting higher prices or less commitment from a carrier.

### SUMMARY

Generally, the invention is directed toward a method and system that performs monitoring of a business process during an operational stage so that notifications are given that the business process may need to be revised. As such, the business process may be revised during the course of the operational stage, and importantly, before another periodic planning stage. An application in which the invention may have particular applicability is with transportation processes.

In one aspect, the invention provides a method of executing a business process during an operational stage where the business process has been formulated during a previous planning stage based on at least one selected parameter that is projected to occur in the operational stage. The method includes monitoring, during the operational stage, the at least one selected parameter. The monitoring is performed to determine if the projection for the at least one selected parameter is accurate. The method also includes revising, during the operational stage, the business process if the projection for the at least one selected parameter is determined to be inaccurate. The revised business process is based on the information related to the at least one selected parameter that is collected during the monitoring of the at least one selected parameter.

In various implementations, the method may include one or more of the following. The business process may be a process for selecting transportation agents to transport goods. In this example, the planning stage may include a task of formulating contracts with transportation agents and formulating rules for the selection of transportation agents. Selected parameters to be monitored may include, for example, an average volume or quantity of goods included in each transport and an average shipping distance for each transport. The revision of the business process may include a reformulation of at least one of the contracts with the transportation agents. Additionally or alternatively, the revision may include a reformulation of at least one of the rules for the selection of transportation agents (such as a capacity constraint parameter).

In another aspect, the invention provides a transportation computer system that performs such functions. The transportation computer has a processor and a computer program comprising instructions that when executed by the processor perform the functions. The functions including executing, during an operational stage, a business process designed in a previous planning stage based on a projection for at least one selected parameter that will occur in the operational stage. Another function of the transportation computer system includes monitoring the selected parameter during the operational stage to determine if the projection for the at least one selected parameter is accurate. Another function is generating, if the projection for the at least one selected parameter is not accurate, a user notification that a revision to the business process should be considered. In various implementations, the transportation computer system may performs other functions, such as those previously described in connection with the method of the invention.

The invention can be implemented to realize one or more of the following advantages. Strategic information can be monitored proactively during real-time processing and the obtained data can be used to trigger change processes for changing strategic data, while executing real-time processes. Consequently, strategic decisions or goals can be continuously revised, which may result in cost savings. Timely decisions can help companies avoid using ex-post analysis, which at best can show that a company should have stopped performing a particular type of activity a long time ago, and that the company may have lost money for a long time period. Furthermore, strategic decisions impact not only logistical parameters, such as capacity, but also real costs. A policy change in a contract, for example, relating to shipments, can result in a changed carrier assignment policy and/or in a changed order structure system, which may lead to significant cost and resource savings for a company. For example, a manufacturer may have a contract with a service provider that serves the northern parts of Kentucky, but various KPI's (for example, represented in a balanced score card) may show that the manufacturer may be better served if the service provider instead is used only for the entire state of Ohio. This will lead to a change in the assignment policy for shipments to service providers, and may also lead to a change of order structure (e.g., no more orders are taken in Kentucky at all), and result in cost savings for the manufacturer.

The details of one or more embodiments of the invention are set forth in the accompanying drawings and the description below. Other features and advantages of the invention will become apparent from the description, the drawings, and the claims.

### DESCRIPTION OF DRAWINGS

FIG. 1 is a diagram illustrating the weight distribution of the goods belonging to a certain shipper.

FIG. 2 is a diagram illustrating tariff structures for two carriers.

FIG. 3 is a diagram illustrating criteria for selecting carriers.

FIG. 4 is a schematic view of a system in accordance with the invention.

Like reference symbols in the various drawings indicate like elements.

### DETAILED DESCRIPTION

The invention provides a way of identifying errors and opportunities in contract allocation based on criteria that link operational and strategic decisions. Through evaluating operative processes, refining the obtained information, and providing feedback and recommendations to strategic decision makers, goals can be redefined or contracts can be renegotiated, which may save significant amounts of money for a company. The invention will be explained by way of example with reference to freight procurement and evaluation of the feasibility for different carriers. However, the general concepts illustrated by the example below can be applied in a variety of different areas in which a company can choose between two or more providers of products or services.

In evaluating operative tasks, there are two major types of analyses: downstream analysis and upstream analysis. Downstream analysis can be described as activities to monitor and evaluate key figures in operational processing in order to identify whether an actual assignment of orders deviates from pre-planned policies that are set forth in the corresponding contracts. One example of downstream analysis is the monitoring of average freight costs per shipment, per weight unit (e.g., tons), or per time interval (e.g. per day). If the monitoring shows deviations from the conditions set forth in the contracts, this indicates problems in the execution of the shipment, or that the contracts do not accurately reflect the current shipment structure or market situation. Downstream analysis is common business practice in shipping departments.

In one implementation of the invention, a modified type of downstream analysis is used. Instead of monitoring only daily numbers or fair-share ratios between carriers, more long-term analytical KPIs are used, such as a moving average, to evaluate not only a daily deviation, but also to study daily trends in view of long-term data recognition, and thereby achieve a smoother and more realistic guidance from KPIs. The invention also uses upstream analysis, which recognizes not only deviations within given ranges, but also indicates based on the downstream KPIs whether to adjust the company's policies, that is, whether to renegotiate and re-evaluate existing contracts, or even to adjust a complete contract portfolio based on the “real” logistical situation.

As was mentioned above, operational base parameters, such as a transportation cost, or a combination of indices (e.g., logistics indices represented in a balanced score card) and an averaged prognosis trend, can be used to determine whether current contract conditions involving logistic processes will remain valid and attractive over a medium or a long time period. When a shipper selects a carrier of goods, the carrier is typically selected based on a number of factors that relate to business motivations and decision parameters for the procurement type. Some factors that are considered in the selection of a carrier can be:

Periodicity—that is, the frequency of contract renegotiation

Performance variation—for example, services offered, frequency of deliveries, number of vehicles, and other characteristics for the carrier.

Decision parameters—for example, price, packing structure, consolidation, regions, coverage carriers, and number of vehicles.

In addition to these factors, there are generally some basic assumptions that are typically made when a carrier is selected. Examples of common basic assumptions include:

Linear relation between time and nominations in operative transport—that is, a contract is valid for a time period and the average contract depreciation remains constant during this time period.

Constant shipment structure during the contract time—that is, when a contract is signed, it is generally assumed that the shipper will provide the carrier with a constant load of goods over a certain time period and that there will be no significant variations in occupancy, for example, due to seasonal variations or variations in size of the goods to be shipped.

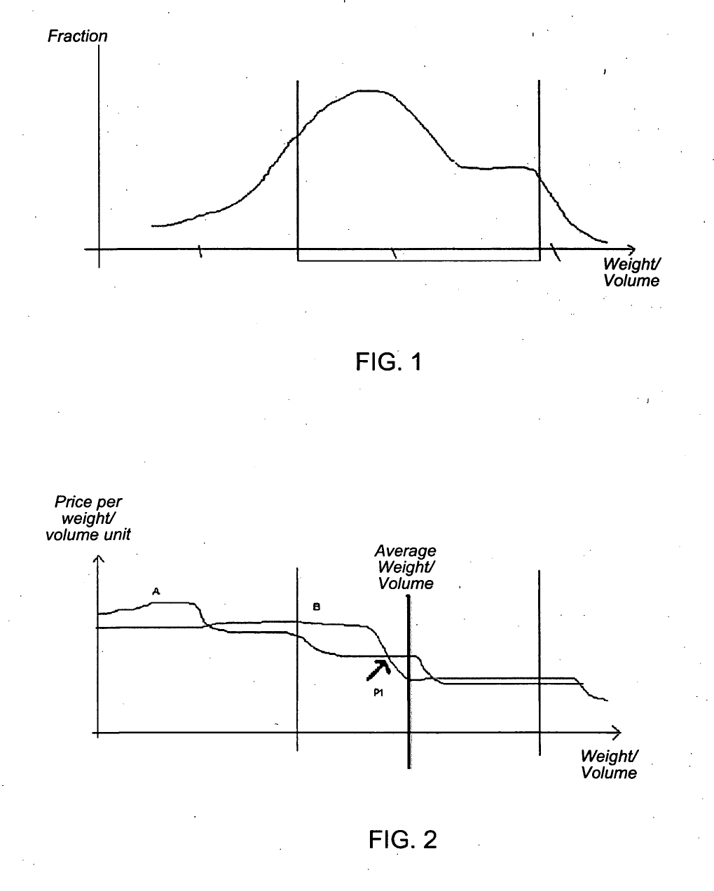

FIG. 1 shows a diagram in which the goods structure for a particular shipper is depicted. Statistically speaking, FIG. 1 is an example of a “relative frequency distribution” of the weight, or alternatively the volume, of shipments. The horizontal axis shows a weight range, or alternatively a volume range, of the types of goods a shipper would like to send. The vertical axis shows a proportion, for example as a fraction between 0 and 1 or a percentage between 0% and 100%. The curve thus shows what the distribution is for different weights for the shipper's goods. The goods structure shown in FIG. 1 may represent historical data collected during a prior operational period. From historical data, it is possible to forecast, in a planning stage, a good structure for an upcoming operational stage.

Next, FIG. 2 shows a diagram containing information about the tariff structure for two carriers. As with FIG. 1, the FIG. 2 data may be historical data, or may be a protection based on historical data and other assumptions. The horizontal axis of the diagram shown in FIG. 2 shows a weight range, or alternatively a volume range, for the goods the shipper would like to send. The vertical axis shows the tariff, such as a price per unit (weight or volume). The curves represent the tariffs for two carriers, A and B, respectively. For example, it can be seen in FIG. 2 that for the lightest types of goods, which is represented in the left hand side of the diagram, carrier B is the least expensive choice. Moving towards the right in the diagram in FIG. 2, the curves cross over and carrier A is the least expensive carrier, except for a small range of weights or volumes in the middle of the range of weights or volumes that are supported by the carriers.

Conventionally, a shipper may select a carrier in the following way. First, the shipper computes an average weight or volume of the goods he or she would like to have shipped. In the diagram in FIG. 1, this corresponds to selecting a value on the horizontal axis that divides the area under the curve in two equal parts. The shipper then checks the tariffs for the carriers for the average weight or volume, and selects the most affordable carrier for the average weight or volume. If the average weight or volume is located as shown in FIG. 2, then carrier B will be selected, whereas if the weight or volume is less than point P1 in FIG. 2, then carrier A will be selected.

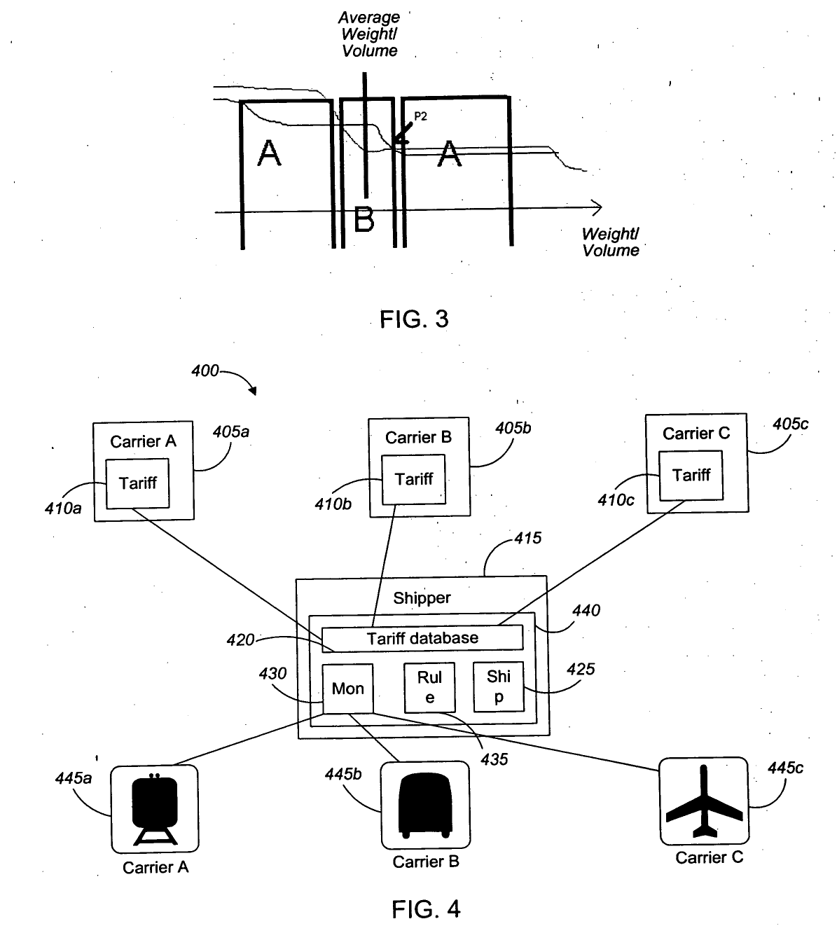

The method of selecting carriers described above may not always result in an optimized solution. For example, as can be seen in FIG. 2, carrier B was selected because carrier B was able to offer the most affordable price for the average weight or volume of the shipper's goods. However, from FIG. 3, which shows a magnified view of the area around the average weight or volume of the curve in FIG. 2, it is clear that carrier B is only the best selection for a relatively narrow weight and volume range. Carrier A is a better alternative if the weight or volume of the goods to be transported changes. It can also be seen in FIG. 3 that carrier A generally covers a larger portion of the goods weights or volumes that the shipper would like to ship, and that carrier A therefore would be a better selection than carrier B.

As can be seen in FIGS. 1 and 2, there is a risk of making an erroneous carrier selection if the only selection criterion is an average key figure. The curve in FIG. 1 shows not only a single high peak, but also a significant number of shipments with high weight (i.e. the area below the right hand side of the curve). As can be seen, the average weight of the shipments does not coincide with the peak of the curve. This means, that it might be beneficial to split the contract for this specific relation into two separate contracts, for example, one contract for low-weight products and another contract for high-weight products, dividing the currently used range. Consequently, the shipments can be priced with two separate tariffs, and may even be handled by two separate carriers if it is economically feasible.

An improvement in carrier selection can also be indicated by analyzing the ratio or percentage for the different weight classes on that relation. Instead of monitoring only three classes (left, main range, right), four classes (left, left main range, right main range, and right range) need to be monitored. Therefore, even if the contracts were to be negotiated based on a single average value, the monitoring could indicate that it would be advantageous to split an existing contract into two contracts, or to renegotiate a portion of the current contract. If the shipper's weight distributions vary over a time period, such as a year, a recommendation may be made to have a contract with carrier A for four months, then with carrier B for four months, and then back to carrier A again for the last four months, for example.

From data such as that shown in FIGS. 1-3, it is possible for a transportation planner to define standard shipment packages that will be used. In addition, the transportation planner may also determine which transportation agent (carrier) or agents will be authorized to be assigned to each of the defined shipment packages. In many cases, more than one transportation agent will be authorized for each shipment package. This is the case because each transportation agent may have capacity constraints, for example, and may not be able to handle all of the shipments of the package that may be needed to be made. In addition, the transportation planner may determine that an optimum possible solution is to favor a certain transportation agent, or that a certain agent should be selected 60% of the time. As discussed previously, contract formation and negotiation with the carriers may occur during the planning stage.

In addition, a number of additional indicators can be used in the process of selecting carriers. In addition to the purely financial aspects discussed above, it is important to monitor other constraints, such as carrier performance requirements and/or the acceptance rate of tendered shipments, for specific carriers. For example, it typically does not make any sense for a shipper to always select the most affordable carrier (based on the contract tariff structure) if the carrier declines half of the shipments. Thus, if a shipper cannot rely on its business partners, the tool offered by this invention will support the shipper with information about which alternative carrier (not only on a price basis) would be beneficial for the shipper's business if a portion of the shipments are moved from the primary carrier to the alternative carrier. Conventional monitoring would merely indicate that the shipper's costs per ton was rising, while in reality the problem may be that the shipper has to switch over to carriers with more expensive rates, because the primary carrier rejects the contracted business shares.

A common problem in conventional monitoring, which can be mitigated with the current invention, is the quality of the indicators. If a shipper only monitors activities on a daily basis, the shipper will not recognize mid-term trends. This is because the daily monitoring assumes that the average ratio will be leveled around the target business share for the overall period and that the usage of a carrier during the complete contract period will be linear. If the shipper's business has seasonal effects, the shipper will lose the opportunity to work together with different carriers over time, fulfilling their business share and contracts, but still working more efficiently.

FIG. 4 shows a transportation system (400) that may be used during an operational stage of a transportation process. A shipper (415) has contracts with three carriers: Carrier A, Carrier B and Carrier C, from which the shipper (415) can select a best candidate to transport a shipment of goods. Each carrier publishes, or makes otherwise available, its tariff structure to the shipper (415), which may also be set forth in the contract with the carrier. The publishing of the tariff structures can take place in any format, but is preferably done electronically, so that the shipper can access the tariff structure over a computer network, such as the Internet. The shipper (415) typically collects the various carriers' tariff structures and capacity in a tariff and capacity database (420) in order to easily make comparisons between the different carriers' tariffs and available capacity for a given shipment. As was described above, different shippers have different types of goods to transport, and the same carrier may not always be the best choice for transporting all the goods a shipper (415) needs to send. In order to facilitate getting an overview of the different types of loads that need to be shipped, the shipper (415) has a computer system (440) that includes a shipping module (425) in which the different types of goods to be shipped are registered.

The shipper's computer system (440) also includes a monitoring module (430) that monitors the actual progress of the transport of goods shipments for the different carriers (445a, 445b, 445c). The monitoring of shipment activities can occur continuously in real time, for example, through the use of Radio Frequency ID (RFID) tags on the goods that is transported, or occur intermittently, for example, by a carrier sending reports to the shipper (415) when the goods enter certain checkpoints, such as loading terminals, customs offices, and so on. The data collected by the monitoring module (430) is compared against past projections (or assumptions) upon which the rules used in the selection of carriers was based, and if the past projections prove to have been incorrect, a notification may be given to notify that the rules may need to be altered.

The computer system (440) also contains a rule module (435) in which rules can be entered, for example, for selecting which carrier will be nominated, or assigned, to a particular shipment. In some cases, the system (440) may produce information that more than one carrier may be selected, and it is up to the shipping agent to determine which transportation is available or best suited to perform the shipment. The rules contained in the rule module (435) include the rules that are initially formulated during the planning stage for the operational stage of the transportation process, which also may be revised during the course of the operational stage of the transportation process.

Using the rules within the rule module (435), the computer system (440) may provide a carrier selection, since the computer system (440) has access to the various tariffs through the tariff and capacity database (420), the shipment sizes through the shipment module (425), and the performance of the various carriers through the monitoring module (430). Although the system (400) has been described above as a computerized, fully automatic system, some or all parts of the system can be replaced with manual operations, data entries, and so on. However, this may increase the risk of errors and inconsistencies, as well as adversely affect the speed with which the system (400) operates, due to the human interactions with the system (400).

As such, the system (400) executes a transportation business process during an operational stage of the transportation process. The transportation business process was initially formulated during a previous planning stage, and was formulated based on at least one selected parameter that is projected to occur in the operational stage. The system (400) monitors the at least one selected parameter. The monitoring is performed to determine if the projection for the at least one selected parameter is accurate. As such, during the operational stage, the business process may be revised if the projection for the at least one selected parameter is determined to be inaccurate. The revised business process is based on the information related to the at least one selected parameter that is collected during the monitoring of the at least one selected parameter.

The parameters that may be selected to be monitored during the operational stage of the transportation business process may include, for example, an average volume or quantity of goods included in each transport and an average shipping distance for each transport. Using the example of monitoring the average volume or quantity of goods being shipped, it may be the case that different packages should be defined. This is one example of a revision to the business process that may be made during the course of the operational stage of the business process by virtue of the monitoring of selected parameters that the system (400) performs. The revision of the business process may also include a reformulation of at least one of the contracts with the transportation agents. Additionally or alternatively, the revision may include a reformulation of at least one of the rules for the selection of transportation agents (such as a capacity constraint parameter). In this example, the planning stage may include a task of formulating contracts with transportation agents and formulating rules for the selection of transportation agents.

The above examples have been simplified to focus on the obvious financial advantage. However, the shipment structure is also based on other key figures and has a time component. As was mentioned above, during the contract period the carrier selection is often based on the assumption that the offer and usage of resources or allocations will be constant over time (often referred to as linear usage). It may be advantageous to recognize seasonal deviations in usage (i.e., demand for resources) in a shipment structure and change allocation shares of different carriers over time to achieve an overall optimization of freight assignments to carriers. This means to adapt “sub-period-business shares” of carriers over the contract time without changing the overall ratio or the allocation quantity in total. This effect is ignored in all existing applications, and only occasionally considered if the logistics planning is performed by a person with significant experience and intimate familiarity with the demand situation of his company over time and in detail.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example, in the above examples, only the shipment structure is considered. It is however also possible to monitor other logistic characteristics, such as transport time for different carriers. In some cases, it may, for example, make sense to switch from a carrier using railroads to a carrier using trucks. Accordingly, other embodiments are within the scope of the following claims.

1. A method of executing a business process during an operational stage, wherein the business process is formulated during a planning stage based on at least one selected parameter that is projected to occur in the operational stage, the method comprising:
monitoring, during the operational stage, the at least one selected parameter to determine if the projection for the at least one selected parameter is accurate; and
revising, during the operational stage, the business process if the projection for the at least one selected parameter is determined to be inaccurate, the revised business process being based on the information related to the at least one selected parameter that is collected during the monitoring of the at least one selected parameter.

2. The method of claim 1 wherein the business process is a process for selecting transportation agents to transport goods.

3. The method of claim 2 wherein the planning stage comprises a task of formulating contracts with transportation agents and formulating rules for the selection of transportation agents.

4. The method of claim 2 wherein the at least one selected parameter includes an average volume or quantity of goods included in each transport.

5. The method of claim 2 wherein the at least one selected parameter includes an average shipping distance for each transport.

6. The method of claim 3 wherein the revision of the business process comprises a reformulation of at least one of the contracts with the transportation agents.

7. The method of claim 3 wherein the revision of the business process comprises a reformulation of at least one of the rules for the selection of transportation agents.

8. The method of claim 7 wherein the at least one reformulated rules comprises a capacity constraint for a carrier.

9. The method of claim 8 wherein the at least one parameter includes a capacity constraint parameter.

10. A transportation computer system comprising a processor and a computer program comprising instructions that when executed by the processor perform the following functions:
executes, during an operational stage, a business process designed in a planning stage based on a projection for at least one selected parameter that will occur in the operational stage;
monitors the selected parameter during the operational stage to determine if the projection for the at least one selected parameter is accurate; and
generates, if the projection for the at least one selected parameter is not accurate, a user notification that a revision to the business process should be considered.

11. The method of claim 10 wherein the business process is a process for selecting transportation agents to transport goods.

12. The method of claim 11 wherein the planning stage comprises a task of formulating contracts with transportation agents and formulating rules for the selection of transportation agents.

13. The method of claim 11 wherein the at least one selected parameter includes an average volume or quantity of goods included in each transport.

14. The method of claim 11 wherein the at least one selected parameter includes an average shipping distance for each transport.

15. The method of claim 12 wherein the revision of the business process that should be considered comprises a reformulation of at least one of the contracts with the transportation agents.

16. The method of claim 12 wherein the revision of the business process that should be considered comprises a reformulation of at least one of the rules for the selection of transportation agents.

17. The method of claim 16 wherein the at least one reformulated rules comprises a capacity constraint for a carrier.

18. The method of claim 17 wherein the at least one parameter includes a capacity constraint parameter.
